(19) United States
(12) Patent Application Publication
(10) Pub. No.: US 2022/0250658 A1
(43) Pub. Date: Aug. 11, 2022

(54) AUTOMATICALLY SELECTING AND OPERATING UNMANNED VEHICLES TO ACQUIRE INSPECTION DATA DETERMINED BASED ON RECEIVED INSPECTION REQUESTS

(71) Applicant: Percepto Robotics Ltd, ModiIn (IL)

(72) Inventors: Sagi BLONDER, Ness Ziona (IL); Ehud ZOHAR, Ramat HaSharon (IL)

(73) Assignee: Percepto Robotics Ltd, ModiIn (IL)

(21) Appl. No.: 17/170,943

(22) Filed: Feb. 9, 2021

(51) Int. Cl. B60W 60/00; G08G 9/00; G05D 1/02; G05D 1/10

(52) U.S. Cl. CPC B60W 60/00259; G08G 9/00; G05D 1/0212; G05D 1/0287; G05D 1/104; B60W 2420/52; G05D 1/0242; G05D 1/0257; G05D 2201/0207; B60W 2420/40; B60W 2420/42; G05D 1/0206

(57) ABSTRACT

Disclosed herein are methods and systems for automatically selecting and operating autonomous vehicles to acquire inspection data relating to one or more inspected assets in response to received inspection request indicating the inspected assets. In particular, based on the inspection request required inspection data is automatically determined by analyzing one or more structural models representing the inspected asset(s) and mission parameters are computed for an inspection mission for acquiring the inspection data. Operational parameters of a plurality of autonomous vehicles are then analyzed with respect to the computed mission parameters to identify one or more autonomous vehicles which are capable of acquiring the inspection data. Operation instructions are further computed for one or more capable autonomous vehicles selected for the inspection mission to acquire the required inspection data and transmitted for operating the selected capable autonomous vehicle(s) accordingly.

### FIELD AND BACKGROUND OF THE INVENTION

The present invention, in some embodiments thereof, relates to operating autonomous vehicles to acquire inspection data relating to assets, and, more specifically, but not exclusively, to automatically selecting and operating autonomous vehicles to optimize inspection missions launched to acquire inspection data relating to assets based on mission parameters automatically computed based on received inspection requests.

In the past, the use of autonomous vehicles either ground, aerial and/or naval vehicles was mainly restricted to military applications and uses due to the high cost of this technology and the resources required for deploying and maintaining such autonomous vehicles.

However, recent years have witnessed constant advancements in autonomous vehicles technology presenting constantly increasing operational capabilities and increased availability of cost effective autonomous vehicles solutions. These trends have led to appearance and rapid evolution of a plurality of commercial, agricultural, environment preservation and other autonomous vehicles based applications, systems and services.

### SUMMARY OF THE INVENTION

According to a first aspect of the present invention there is provided a method of automatically selecting and operating autonomous vehicles to optimize inspection mission launched to acquire inspection data, comprising using one or more processors for:
Receiving a request to inspect one or more of a plurality of assets.
Analyzing one or more structural models representing the one or more assets to determine required inspection data and compute a plurality of mission parameters of an inspection mission for acquiring the inspection data.
Analyzing a plurality of operational parameters of each of a plurality of autonomous vehicles with respect to the plurality of mission parameters to identify one or more of the plurality of autonomous vehicles which are capable of acquiring the inspection data.
Computing operation instructions for one or more capable autonomous vehicles selected to acquire the inspection data.
Transmitting the operation instructions for operating the one or more selected capable autonomous vehicles to acquire the inspection data.

According to a second aspect of the present invention there is provided a system for automatically selecting and operating autonomous vehicles to optimize inspection mission launched to acquire inspection data, comprising one or more processors configured to execute a code. The code comprising:
Code instructions to receive a request to inspect one or more of a plurality of assets.
Code instructions to analyze one or more structural models representing the one or more assets to determine required inspection data and compute a plurality of mission parameters of an inspection mission for acquiring the inspection data.
Code instructions to compute a plurality of mission parameters based on the one or more asset attributes.
Code instructions to analyze a plurality of operational parameters of each of a plurality of autonomous vehicles respect to the plurality of mission parameters to identify one or more of the plurality of autonomous vehicles which are capable of acquiring the inspection data.
Code instructions to compute operation instructions for one or more capable autonomous vehicles selected to acquire the inspection data.
Code instructions to transmit the operation instructions for operating the one or more selected capable autonomous vehicles to acquire the inspection data.

According to a second aspect of the present invention there is provided a computer program product comprising program instructions executable by a computer, which, when executed by the computer, cause the computer to perform a method according to the first aspect.

In a further implementation form of the first, second and/or third aspects, the acquired inspection data is used for one or more of: generating an inspection report relating to the one or more assets and enhancing the one or more structural model representing the one or more assets.

In an optional implementation form of the first, second and/or third aspects, one or more additional inspection missions are initiated to acquire additional inspection data in case it is determined, based on analysis of the acquired inspection data, that the acquired inspection data does not to comply at least partially does with the required inspection data.

In a further implementation form of the first, second and/or third aspects, the analysis of the acquired inspection data compared to the required inspection data is conducted by one or more Machine Learning (ML) models trained using a plurality of training inspection datasets.

In a further implementation form of the first, second and/or third aspects, each of the plurality of autonomous vehicles is a member of a group consisting of: a ground vehicle, an aerial vehicle and/or a naval vehicle.

In a further implementation form of the first, second and/or third aspects, the plurality of assets comprise one or more of: a geographical area, a structure, an infrastructure and/or a stockpile.

In a further implementation form of the first, second and/or third aspects, the one or more structural models representing the one or more assets in a three dimensional (3D) space define a plurality of asset attributes of the one or more assets. The plurality of asset attributes comprise: a location, a structure, a perimeter, a dimension, a shape, an exterior surface, an inspection constraint and/or an accessibility.

In a further implementation form of the first, second and/or third aspects, the mission parameters further comprise one or more mission constraints for the inspection mission. The one or more mission constraint is a member of a group consisting of: a mission start time, a mission end time, a section of the one or more asset and a maximum mission cost.

In a further implementation form of the first, second and/or third aspects, each of the plurality of autonomous vehicles is equipped with one or more sensors configured to capture at least data. The one or more sensor is a member of a group consisting of: a visual light camera, a video camera, a thermal camera, a night vision sensor, an infrared camera, an ultraviolet camera, a depth camera, a ranging sensor, a Laser imaging, Detection and Ranging (LiDAR) and/or a Radio Detection and Ranging (RADAR).

In a further implementation form of the first, second and/or third aspects, the plurality of operational parameters include at least some members of a group consisting of: a speed, a range, an altitude, maneuverability, a power consumption, availability, an operational cost, a resolution of the one or more sensor, a Field of View (FOV) of the one or more sensors and/or a range of the one or more sensors.

In a further implementation form of the first, second and/or third aspects, the operational parameters of one or more of the plurality of autonomous vehicles further include a capability of the respective one of the plurality of autonomous vehicles to acquire the inspection data under one or more environmental conditions. Each of the one or more environmental conditions is a member of a group consisting of: temperature, humidity, illumination, rain, snow, haze, fog and/or smog.

In a further implementation form of the first, second and/or third aspects, the one or more capable autonomous vehicles are selected according to one or more optimization functions. The one or more optimization functions are directed to minimize one or more operational objectives of the inspection mission. The one or more operational objective are members of a group consisting of: a shortest route, a lowest operational cost, a minimal number of autonomous vehicles, a shortest mission time and/or a maximal utilization of the plurality of autonomous vehicles.

In an optional implementation form of the first, second and/or third aspects, the one or more processors are further configured for:
Computing a plurality of instruction sets each for a respective one of a plurality of operation plans for one or more autonomous vehicles identified to be capable of acquiring the inspection data.
Selecting an optimal operation plan from the plurality of operation plans according to one or more of the optimization functions.

In an optional implementation form of the first, second and/or third aspects, the one or more processors are further configured for:
Splitting the inspection mission to a plurality of sub-missions.
Selecting a plurality of capable autonomous vehicles each capable to accomplish a respective one of the plurality of sub-missions.
Computing operation instructions for each of the plurality of capable autonomous vehicles to carry out the respective sub-mission.

In a further implementation form of the first, second and/or third aspects, the operation instructions further comprise one or more reference elements for use by the one or more selected capable autonomous vehicle to identify one or more asset features of the one or more assets during the inspection mission. The one or more reference element is a member of a group consisting of: an image of the one or more asset feature, a feature vector representing the one or more asset feature, a simulation of the one or more asset feature, a visual identification code attached to the at least asset feature and/or a transmitted identification code transmitted in proximity to the one or more asset features via one or more short range wireless transmission channels.

In a further implementation form of the first, second and/or third aspects, the operation instructions computed for the one or more selected capable autonomous vehicles define a route between at least some of the plurality of assets in case the request relates to inspection of multiple assets of the plurality of assets.

In an optional implementation form of the first, the inspection mission is scheduled according to one or more environmental conditions during which the one or more capable autonomous vehicles are estimated to successfully accomplish the inspection mission.

In an optional implementation form of the first, second and/or third aspects, the one or more processors are further configured for:
Receiving a plurality of requests to inspect multiple assets of the plurality of assets.
Determining the inspection data required for each of the plurality of requests.
Selecting one or more capable autonomous vehicles to acquire the required inspection data.
Computing operation instructions for a plurality of inspection missions for the one or more selected capable autonomous vehicle to acquire the required inspection data.
Scheduling the plurality of inspection missions according to availability of the one or more selected capable autonomous vehicles.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks automatically. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of methods and/or systems as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars are shown by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process of automatically selecting and operating autonomous vehicle(s) to acquire inspection data relating to one or more assets based on mission parameters derived from an inspection request, according to some embodiments of the present invention;

FIG. 2 is a schematic illustration of an exemplary system for automatically selecting and operating autonomous vehicle(s) to acquire inspection data relating to one or more assets based on mission parameters derived from an inspection request, according to some embodiments of the present invention;

FIG. 3A and FIG. 3B are screen captures of exemplary Graphic User Interfaces (GUI) used by users to issue requests for inspecting one or more assets, according to some embodiments of the present invention;

FIG. 4A and FIG. 4B are schematic illustrations of a structural model representing an exemplary silo site comprising a plurality of silo assets in three dimensional (3D) space used for acquiring inspection data relating to the silo site, according to some embodiments of the present invention;

FIG. 5 is a screen capture of exemplary inspection data of an exemplary silo asset acquired by autonomous vehicle(s) selected and operated automatically according to mission parameters derived from an inspection request, according to some embodiments of the present invention; and

FIG. 6 is a screen capture of an exemplary inspection report generated for an exemplary silo asset based on data acquired by autonomous vehicle(s) selected and operated automatically according to mission parameters derived from an inspection request, according to some embodiments of the present invention.

### DESCRIPTION OF SPECIFIC EMBODIMENTS OF THE INVENTION

The present invention, in some embodiments thereof, relates to operating autonomous vehicles to acquire inspection data relating to assets, and, more specifically, but not exclusively, to automatically selecting and operating autonomous vehicles to optimize inspection missions launched to acquire inspection data relating to assets based on mission parameters automatically computed based on received inspection requests.

According to some embodiments of the present invention, there are provided methods, systems and computer program products for automatically selecting and operating one or more autonomous vehicles, for example, an aerial autonomous vehicle, a ground, autonomous vehicle, a naval autonomous vehicle and/or the like to acquire (collect, capture, etc.) inspection data relating to one or more assets, for example, a geographical area (e.g. rural region, agricultural area, urban area, etc.) a structure (e.g. building, factory, a storage silo, a solar panels field, etc.) an infrastructure (e.g. road, railway, pipeline, etc.), a stockpile (e.g. woodpile, building material, etc.) and/or the like.

In particular, the autonomous vehicle(s) may be selected and operated in one or more inspection missions to acquire the inspection data in response to one or more requests to inspect one of more of the assets. The requests which may be received from one or more users and/or one or more automated systems and/or services may be directed to identify and/or determine one or more conditions, states and/or activities relating to one or more of the assets.

The inspection data acquired in the inspection mission(s) may be used for one or more applications, for example, generating an inspection report relating to one or more of the inspected assets, generating and/or enhancing one or more structural models of one or more of the inspected assets and/or the like.

In response to receiving the request to inspect one or more of the assets, a mission engine may first determine the required inspection data relating to the asset(s) to be inspected by analyzing one or more structural models of the asset(s). The structural model(s) which represent the inspected asset(s) in a 3D space may define one or more of a plurality of asset attributes of each of the asset(s), for example, location, structure, perimeter, dimension(s), shape, exterior surface(s), surface texture(s) and/or the like. The asset attributes defined by the structural model(s) may further include one or more inspection constraints, accessibility constraints and/or the like which may express limitations the ability to access and/or inspect the inspected asset(s).

After determining the required inspection data, the mission engine may compute one or more mission parameters for an inspection mission by one or more autonomous vehicles launched in order to acquire the required inspection data. The mission parameters may be computed based on, for example, the structural model(s) representing the inspected asset(s), data extracted from the inspection request, learned data and/or the like. The mission parameters may include, for example, one or more viewpoints for capturing inspection data, specifically sensory data depicting the inspected asset(s) and/or part thereof, one or more capture angles for capturing the sensory data, one or more resolutions for capturing the sensory data, one or more access paths to the inspected asset(s) and/or the like. The mission parameters may further define one or more environmental parameters for the inspection mission, for example, illumination level, maximal temperature, minimal temperature, absent of precipitation (e.g., rain, snow, hail, etc.) and/or the like. The mission parameters may also include and/or define one or more mission constraints for the inspection mission, for example, a mission start time, a mission end time, a section of the inspected asset(s) that needs to be inspected and/or the like.

The mission engine may analyze a plurality of operational parameters of a plurality of autonomous vehicles, specifically with respect to the computed mission parameters in order to identify one or more autonomous vehicles which are determined to be capable of carrying out the inspection mission and successfully acquire the required inspection data. The operational parameters may include, for example, a type (aerial, ground, naval), terrain capability, speed, range, altitude, maneuverability, power consumption, availability, operational cost and/or the like. moreover, each of the autonomous vehicles may be equipped with one or more sensors, for example, an imaging sensor (e.g. camera, video camera, night vision camera, Infrared camera, thermal imaging sensor, etc.), a depth and/or ranging sensor (e.g., Light imaging, Detection, and Ranging (LiDAR) sensor, Radio Detection and Ranging (RADAR) sensor, Sound Navigation Ranging (SONAR) sensor, etc.) and/or the like. The operational parameters of each of the autonomous vehicles may therefore further include one or more operational parameters of their sensors, for example, number of sensors, sensing technology, resolution, Field of View (FOV), required illumination and/or the like. The operational parameters of one or more of the autonomous vehicles may also include a capability of the respective autonomous vehicle to operate and acquire the inspection data, in particular sensory data under one or more environmental conditions.

The mission engine may select one or more of the capable autonomous vehicles to actually carry out (conduct) the inspection mission to acquire the required inspection data. Specifically, the mission engine may select the capable autonomous vehicle(s) according to one or more optimization functions directed to minimize one or more operational objectives of the inspection mission, for example, shortest route of the autonomous vehicle(s), lowest operational cost of the autonomous vehicle(s), a minimal number of autonomous vehicle(s), shortest mission time, earliest inspection mission completion time, maximal utilization of the plurality of autonomous vehicles and/or the like.

The mission engine may compute operation instructions for the selected capable autonomous vehicle(s) which may be applied by the selected capable autonomous vehicle(s) to conduct the inspection mission and acquire the required inspection data.

The inspection data acquired by the selected capable autonomous vehicle(s) may include sensory data captured by the sensor(s) of the selected capable autonomous vehicle(s), for example, imagery data, thermal mapping data, range and/or depth maps and/or the like. The acquired inspection data may be used for one or more applications. For example, the acquired inspection data may be analyzed to generate an inspection report relating to the inspected asset(s) which may include, for example, information relating to the state, condition, activity and/or the like of and/or relating to the inspected asset(s). The inspection report may further include one or more recommendations, indications and/or the like, for example, a maintenance recommendations relating to one or more of the inspected asset(s). The inspection report may be then provided to the requester. In another example, the acquired inspection data may be analyzed to create, enhance and/or update one or more of the structural models of one or more of the inspected assets.

Optionally, the mission engine may initiate one or more additional inspection missions to acquire additional inspection data in case the acquired inspection data is incompliant, for example, partial, incomplete, insufficient, insufficiently accurate, under quality and/or the like. The mission engine may initiate the additional inspection mission(s) based on analysis of the acquired inspection data, specifically with respect to the required inspection data to determine the compliance of the actually acquired inspection data with the computed required inspection data.

Optionally, one or more Machine Learning (ML) models, for example, a neural network, a Support Vector Machine (SVM) and/or the like may be trained and/or learned to analyze the acquired inspection data to determine quality, accuracy, completeness and/or the like of the acquired inspection data. Moreover, the ML model(s) may be further trained and/or learned to analyze the acquired inspection with respect to the required inspection data to evaluate the compliance of the acquired inspection data with the computed required inspection data.

Optionally, the mission engine schedules one or more of the inspection missions according to one or more of the mission parameters defining a preferred time of execution.

Optionally, the mission engine splits one or more of the inspection missions to a plurality of sub-missions each targeting a respective portion of the required inspection data of the respective inspection mission and assigned to a respective one of the autonomous vehicles.

Optionally, the mission engine schedules a plurality of inspection missions according to availability of the autonomous vehicles.

Optimizing the inspection missions by automatically selecting and operating the autonomous vehicles to acquire the automatically determined required inspection data may present major benefits and advantages compared to existing methods and system for operating autonomous vehicles.

First, the existing (traditional) methods for operating autonomous vehicles to accomplish the coverage task typically rely on manual work by one or more users, typically professional and/or expert users which are proficient in defining mission parameters for inspection missions and allocating autonomous vehicles accordingly to carry out the inspection missions. Such manual labor may be naturally highly limited in its ability to scale to multiple inspection mission relating to multiple assets and/or to complex inspection missions of detailed and/or large assets. In contrast, automatically computing the mission parameters based on the structural models of the assets and automatically identifying autonomous vehicles which are capable of successfully accomplishing the inspection mission may be easily scaled for practically any number of inspection mission and/or assets.

Moreover, scalability of manually generated inspection missions, i.e. computing mission parameters and/or operational instructions for the autonomous vehicles may be further limited when the fleet of autonomous vehicles available for the inspection missions is large and/or diverse in its operational capabilities. This limitation stems from the fact that a huge number of operational parameters of the multitude of autonomous vehicles must be considered specifically with respect to the requirements and considerations of the inspection missions. On the other hand, automatically analyzing the operational parameters of the autonomous vehicles, specifically with respect to the automatically computed mission parameters may be scaled for large and diverse fleets of autonomous vehicles having various inspection capabilities.

Furthermore, automatically allocating a large number of autonomous vehicles for a large number of inspection missions and automatically operating them accordingly may significantly optimize the inspection missions, for example, improve utilization of the autonomous vehicles fleet, reduce operational cost of the autonomous vehicles, reduce inspection mission time and/or the like. This is in contrast to the existing methods which rely on manual inspection missions' construction and manual autonomous vehicles allocation which may be extremely difficult and potentially impassible thus leading to sub-optimal inspection mission, resulting in poor utilization, increased operational costs and/or increased missions time.

In addition, determining the required inspection data and computing the mission parameters accordingly based on the structural model(s) of the inspected asset(s) may optimize the inspection mission(s) since the inspection data acquired by the autonomous vehicle(s) may be significantly improved in terms of, for example, increase accuracy, quality and/or reliability. Moreover, due to the improved accuracy, quality and/or reliability of the acquired inspection data, the number of autonomous vehicles needed in the inspection mission(s) and/or the number of inspection missions launched to acquire the inspection data may be significantly reduced thus further reducing costs. This is a major advantage over the manual mission generation based existing methods which may yield significantly reduced quality and/or accuracy inspection data thus typically requiring allocation of additional vehicles and/or launch of additional missions to acquire useful inspection data at sufficient quality, accuracy and/or reliability. This additional resource utilization, i.e., additional vehicle and/or additional missions, may naturally further reduce utilization of the autonomous vehicles and/or increase cost and/or time of the inspection missions.

Also, at least some of the operational parameters of the autonomous vehicles may be highly dynamic, for example, availability including future availability, operational costs and/or the like. Manually tracking and evaluating such dynamic parameters may be highly difficult, inefficient and most likely practically impossible. However, automatically analyzing these dynamic parameters may serve for rapid, efficient and effective allocation and/or scheduling of the autonomous vehicles to the inspection mission initiated to acquire the inspection data required for the requested inspection reports.

Automatically identifying and allocating autonomous vehicle(s) capable to conduct each of the inspection mission according to the optimization objectives may result in optimal autonomous vehicles allocation thus significantly improving effective utilization of the autonomous vehicles, increasing the operational life span of the autonomous vehicles, reducing operational costs, reducing maintenance costs and/or the like.

Finally, applying a feedback loop to check compliance of the actually acquired inspection data, optionally with the required inspection data determined in advance (prior to launching the inspection mission) and initiating one or more additional inspection missions in case of non-compliance may further significantly improve accuracy, quality, and/or completeness of the acquired inspection data. Applying the trained ML model(s) to analyze the accuracy, quality, completeness and/or compliance of the acquired inspection data may further improve the acquired inspection data since the ML model(s) may easily adapt to identify inspection data relating to dynamic acquisition conditions, new assets, different autonomous vehicles and sensors and/or the like with no need for complex redesign and/or adjustment effort as may be required for rule based systems.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program code comprising computer readable program instructions embodied on a computer readable medium may be transmitted using any appropriate medium, including but not limited to wireless, wire line, optical fiber cable, RF, etc., or any suitable combination of the foregoing.

The computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the present invention may be written in any combination of one or more programming languages, such as, for example, assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

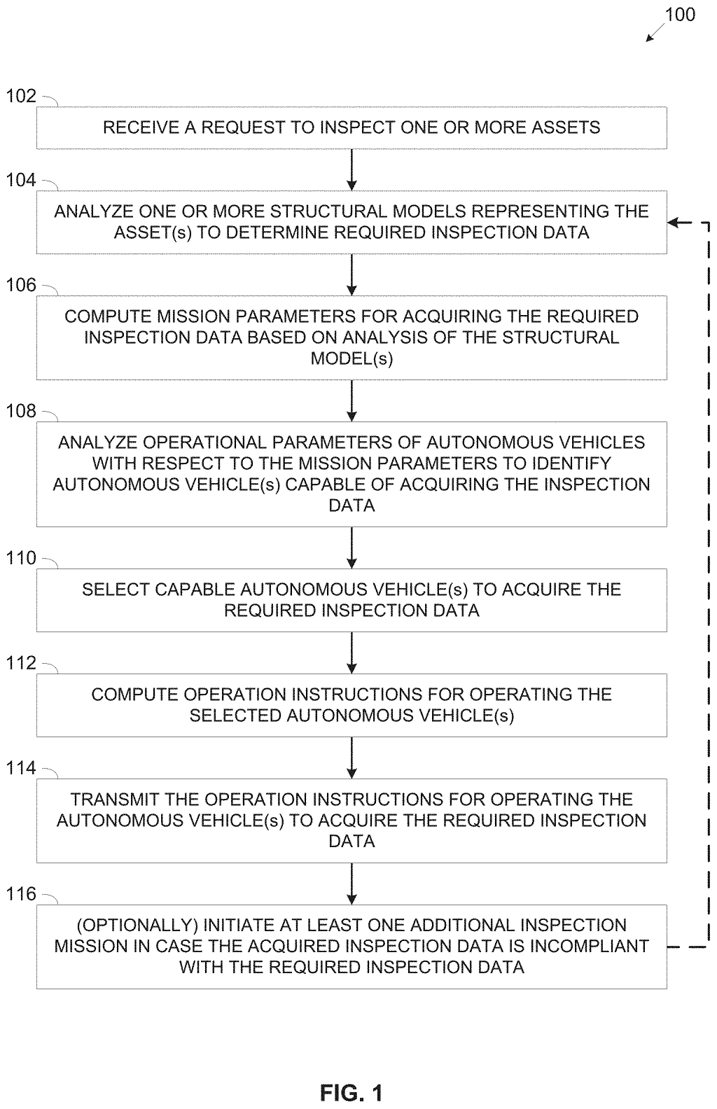

Referring now to the drawings, FIG. 1 is a flowchart of an exemplary process of automatically selecting and operating autonomous vehicle(s) to acquire inspection data relating to one or more assets based on mission parameters derived from an inspection request, according to some embodiments of the present invention.

An exemplary process 100 may be executed to (1) receive a request to inspect one or more assets, for example, a geographical area (e.g. rural region, agricultural area, urban area, etc.) a structure (e.g. building, factory, a storage silo, a solar panels field, etc.) an infrastructure (e.g. road, railway, pipeline, etc.), a stockpile (e.g. woodpile, building material, etc.) and/or the like, (2) automatically select one or more autonomous vehicles, for example, an aerial autonomous vehicle, a ground, autonomous vehicle, a naval autonomous vehicle and/or the like and (3) compute operation instructions for operating the selected autonomous vehicle(s) to acquire inspection data relating to the requested asset(s).

The inspection request which may be received from one or more users and/or one or more automated systems and/or services may be directed to identify and/or determine one or more conditions, states and/or activities relating to one or more of the assets.

Specifically, the inspection data required for the inspection of the asset(s) may be determined automatically based on one or more structural models of the asset(s) to be inspected, in particular structural models representing the asset(s) in a 3D space and define one or more of a plurality of asset attributes of each of the asset(s).

Based on the inspection data determined as required, mission parameters may be computed for an inspection mission to be launched to acquire the required inspection data. The mission parameters may be then used for selecting one or more of the autonomous vehicles which are determined as capable of acquiring the required inspection and for computing operation instructions for the selected capable autonomous vehicle(s) accordingly to acquire the required inspection data.

After acquired, the inspection data may be analyzed and used for one or more applications, for example, to generate one or more inspection reports relating to the inspected asset(s), in another example, the acquired inspection data may be used to create, enhance and/or update one or more of the structural models of the inspected assets and/or the like which may be provided back to the requester.

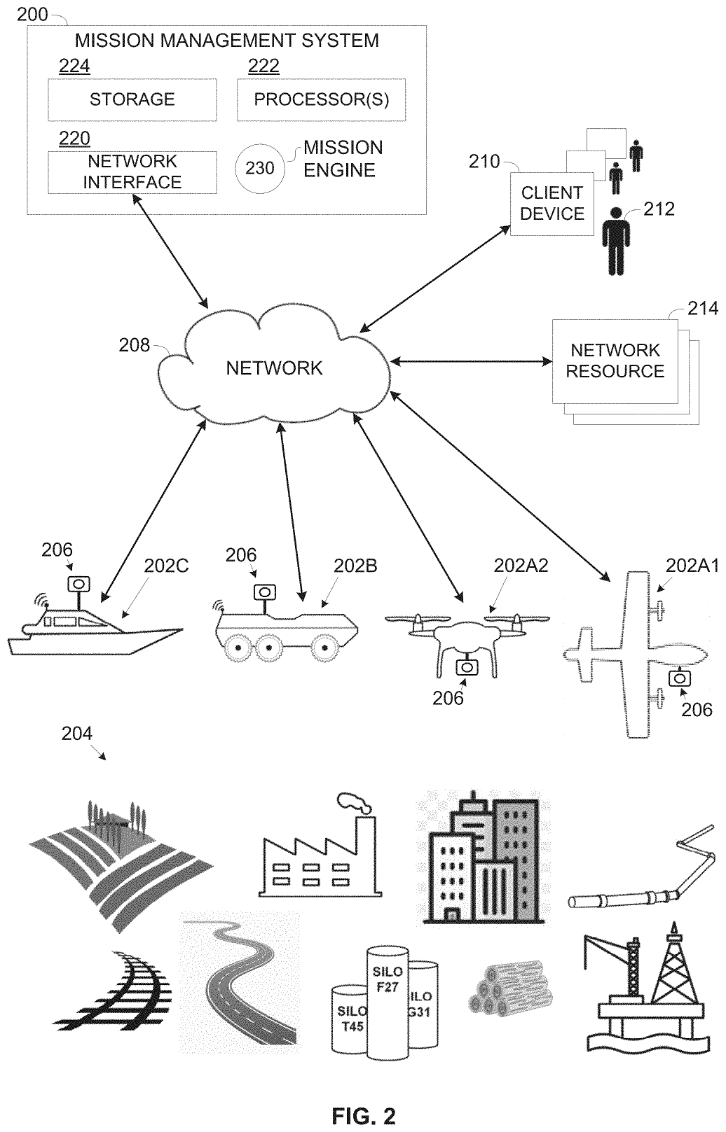

Reference is also made to FIG. 2, which is a schematic illustration of an exemplary system for automatically selecting and operating autonomous vehicle(s) to acquire inspection data relating to one or more assets based on mission parameters derived from an inspection request, according to some embodiments of the present invention.

An exemplary mission management system 200, for example, a computer, a server, a computing node, a cluster of computing nodes, a cloud computing platform and/or the like may be deployed to execute the process 100 for receiving a request to inspect one or more assets 204, analyzing one or more structural models of the asset(s) to determine required inspection data and computing mission parameters accordingly, selecting one or more of a plurality of autonomous vehicles 202 capable of acquiring the inspection data and computing instructions for operating the selected autonomous vehicle(s) 202 accordingly to acquire (collect, capture, etc.) the required inspection data.

The mission management system 200 may receive one or more requests to inspect one or more of the assets 204 from one or more users 212 which may directly interact with the mission management system 200 via one or more user interfaces of the mission management system 200. The mission management system 200 may further receive one or more of the inspection requests from one or more remote users 212 using one or more client devices 210, for example, a computer, a server, a smartphone, a tablet and/or the like to communicate with the mission management system 200 via a network 208. Moreover, one or more of the inspection requests may be received via the network 208 from one or more networked resources 214, for example, an automated system configured to analyze the inspection report(s) and generate alerts, warnings and/or operational instructions accordingly.

The assets 204 may include, for example, one or more geographical areas such as, for example, a rural region, an industrial area, a storage zone, a mine, an energy field, an agricultural area, a farm land, an urban area, a residence district and/or the like. In another example, the assets 204 may include one or more structures, for example, an industrial structure (e.g., factory, silo, hangar, etc.), an energy structure (e.g. solar panel, oil rig, gas drilling rig, etc.), an agricultural structure (e.g. barn, an animals shed, etc.), an urban structure (e.g. house, residential building, office building, etc.), a commercial structure (e.g. shopping mall, store, etc.) and/or the like. In another example, the assets 204 may include one or more infrastructures such as, for example, road, railway, pipeline, transportation infrastructure (e.g. traffic lights, signs, etc.) and/or the like. In another example, the assets 204 may include one or more stockpiles, for example, woodpile, building material pile and/or the like.

The autonomous vehicles 202 may include various vehicles, for example, aerial vehicles 202A, ground vehicles 202B, naval vehicles 202C and/or the like. The aerial autonomous vehicles 202A may include one or more types of aerial vehicles, for example, an Unmanned Aerial Vehicle (UAV) 202A1, a drone 202A2 and/or the like. The ground autonomous vehicles 202B may include one or more types of ground vehicles, for example, a car, a rover, a tracked vehicle and/or the like. The naval autonomous vehicles 202C may include one or more types of naval vehicles, for example, a boat, a hovercraft, a submarine and/or the like.

The autonomous vehicles 202 may be designed, adapted, configured and/or equipped for carrying out inspection missions launched to inspect one or more of the assets and acquire (e.g., capture, collect, etc.) inspection data which may be analyzed to identify and/or determine one or more conditions, states and/or activities relating to one or more of the assets.

The inspection mission may include, for example, surveying, monitoring, observing, scanning and/or the like one or more of the assets in order to collect the inspection data. For example, a certain inspection mission may be launched to inspect an agricultural crop field in order to collect inspection data which may be analyzed to determine, for example, a growth state and/or condition of the crop. In another example, a certain inspection mission may be directed to inspect a certain structure, for example, a storage silo to identify, for example, a corrosion state the silo's construction. In another example, a certain inspection mission may be initiated to inspect a certain infrastructure, for example, a train railway to identify, for example, a wearing condition of the railway. In another example, a certain inspection mission may be launched to inspect an oil rig located in sea to identify, for example, an integrity state of the rig's support structure.

In order to carry out the inspection missions, the autonomous vehicles 202 may be equipped (e.g. installed, mounted, integrated, attached, etc.) with one or more sensors 206 configured to capture sensory data of the environment of the autonomous vehicles 202. The sensor(s) 206 may employ one or more sensing technologies and methods. For example, the sensors 206 may include one or more imaging sensors, for example, a camera, a video camera, a night vision camera, an Infrared camera, a thermal imaging sensor, a thermal imaging camera and/or the like configured to capture sensory data, specifically imagery data, for example, images, video streams, thermal images and/or the like of the environment of the autonomous vehicles 202. In another example, the sensors 206 may include one or more depth and/or ranging sensors, for example, a LiDAR sensor, a RADAR sensor, a SONAR sensor and/or the like configured to capture sensory data, specifically ranging data, for example, depth data, range data and/or the like in the environment of the autonomous vehicles 202 such that one or more depth maps, range maps and/or distance maps may be created based on the captured ranging data.

The autonomous vehicles 202 may differ from each other in one or more of their operational parameters, for example, a type (aerial, ground, naval), terrain capability, speed, range, altitude, maneuverability, power consumption, availability, operational cost and/or the like. For example, while the ground autonomous vehicles 202B are directed for operation in ground terrains and the naval autonomous vehicles 202C may be operated in water environments, the aerial autonomous vehicles 202A may be operated in a plurality of environments over both ground or water. In another example, the altitude and/or range of one or more of the aerial autonomous vehicles 202A, for example, the UAV 202A1 or the drone 202A2 may be significantly higher compared to the ground autonomous vehicles 202B. In another example, while the range and/or altitude of the UAV 202A1 may be higher than that of the drone 202A2, the maneuverability of the drone 202A2 may be higher compared to the maneuverability of the UAV 202A1. In another example, a first ground autonomous vehicle 202B, for example, a tracked vehicle may more capable and better suited of operating in rough terrain compared to a second first ground autonomous vehicle 202B, for example, a wheel based vehicle. However, the capability of the wheel based autonomous vehicle 202B to operate and maneuver over paved and/or smooth surfaces may be significantly higher compared to the tracked autonomous vehicle 202B. In another example, the operational cost of the drone 202A2 may be significantly lower compared to the operational cost of the UAV 202A1.

The autonomous vehicles 202 may also differ from each other in one or more operational parameters of their sensors 206, for example, number of sensors, sensing technology, resolution, FOV, required illumination and/or the like. For example, a certain autonomous vehicle 202 may have a first sensor 206, for example, an imaging sensor such as, for example, the camera while another autonomous vehicle 202 may have a second sensor 206, for example, a ranging sensors such as, for example, the LiDAR. In another example, a certain autonomous vehicle 202 may have a first sensor 206, for example, a visible light camera while another autonomous vehicle 202 may have a second sensor 206, for example, a thermal imaging camera. In another example, a certain autonomous vehicle 202 may have a sensor 206, for example, a LiDAR having a significantly higher resolution compared to the range of another sensor 206, for example, another LiDAR of another autonomous vehicle 202. In another example, a certain autonomous vehicle 202 may have a sensor 206, for example, a visible light camera having a significantly higher FOV compared to the FOV of another sensor 206, for example, another camera of another autonomous vehicle 202. In another example, a certain autonomous vehicle 202 may have more multiple sensors 206, for example, a visible light camera, an Infrared camera and/or the like while another autonomous vehicle 202 may have a single sensor 206, for example, a visible light camera.

The operational parameters of one or more of the autonomous vehicles 202 may further include a capability of the respective autonomous vehicle 202 to operate and acquire the inspection data, in particular sensory data under one or more environmental conditions, for example, temperature (level), humidity (level) illumination (level), rain, snow, haze, fog, smog and/or the like. For example, the operational parameters of one or more autonomous vehicles 202 may indicate that the respective autonomous vehicle 202 may be incapable of operating in snow conditions. In another example, the operational parameters of one or more autonomous vehicles 202 may indicate that the respective autonomous vehicle 202 may be highly navigable and may be able to operate even under heavy rain conditions. In another example, the operational parameters of one or more autonomous vehicles 202 may indicate that the sensor 206 of the respective autonomous vehicle 202 may be incapable to acquire (capture) sensory data, for example, thermal mapping data in high temperature environment.

The mission management system 200 may comprise a network interface 220 for connecting to a network 208, a processor(s) 222 for executing the process 100 and a storage 224 for code storage (program store) and/or data store.

The network interface 220 may include one or more network and/or communication interfaces for connecting to the network 208 comprising one or more wired and/or wireless networks, for example, a Local Area Network (LAN), a Wireless Local Area Network (WLAN), a Wide Area Network (WAN), a Municipal Area Network (MAN), a cellular network, the internet and/or the like. Via the network interface 220, the mission management system 200 may connect to the network 208 for communicating with one or more of the networked resources 214, one or more of the client devices 210 used by the one or more of the users 212 and/or to one or more of the autonomous vehicles 202.

The processor(s) 222, homogenous or heterogeneous, may include one or more processors arranged for parallel processing, as clusters and/or as one or more multi core processor(s). The storage 224 may include one or more non-transitory persistent storage devices, for example, a Read Only Memory (ROM), a Flash array, a hard drive and/or the like. The storage 224 may also include one or more volatile devices, for example, a Random Access Memory (RAM) component, a cache memory and/or the like. The storage 224 may further include one or more networked storage resources, for example, a Network Attachable Storage (NAS), a storage server, a storage cloud service and/or the like accessible via the network interface 220.

The processor(s) 222 may execute one or more software modules such as, for example, a process, a script, an application, an agent, a utility, a tool, an Operating System (OS) and/or the like each comprising a plurality of program instructions stored in a non-transitory medium (program store) such as the storage 224 and executed by one or more processors such as the processor(s) 222. The processor(s) 222 may optionally utilize and/or facilitate one or more hardware elements (modules) integrated and/or utilized in the mission management system 200, for example, a circuit, a component, an Integrated Circuit (IC), an Application Specific Integrated Circuit (ASIC), a Field Programmable Gate Array (FPGA), a Digital Signals Processor (DSP), a Graphic Processing Unit (GPU) and/or the like.

The processor(s) 222 may therefore execute one or more functional modules implemented using one or more software modules, one or more of the hardware modules and/or combination thereof. For example, the processor(s) 222 may execute a mission engine 230 for executing the process 100.

The mission management system 200 may optionally include a user interface comprising one or more user interfaces, for example, a keyboard, a keypad, a pointing device (e.g., mouse, trackball, etc.), a touch screen, a screen, an audio interface (e.g. speaker, microphone, etc.) and/or the like. The user interface may be used by one or more users such as the user 212 to interact with the mission management system 200, specifically with the mission engine 230.

Optionally, the mission management system 200, specifically the mission engine 230 may be implemented using one or more cloud computing services, for example, an Infrastructure as a Service (IaaS), a Platform as a Service (PaaS), a Software as a Service (SaaS) and/or the like such as, for example, Amazon Web Service (AWS), Google Cloud, Microsoft Azure and/or the like.

Each of the autonomous vehicles 202 may include one or more processing units for controlling its operation. One or more of the autonomous vehicles 202 may optionally include one or more Input/Output (I/O) interfaces for connecting to one or more peripherals, for example, memory, persistent storage, application specific components and/or the like. Each of the autonomous vehicles 202 may further include one or more communication and/or interconnection interfaces for connecting to one or more external devices, systems, networks and/or the like to receive data, for example, operational instructions and to transmit data, for example, data acquired during one or more inspection missions.

The mission management system 200, specifically the mission engine 230 may communicate with the autonomous vehicles 202 via one or more networks and/or interconnections depending on the communication capabilities of each autonomous vehicle 202 and/or the deployment of the mission management system 200. For example, assuming one or more of the autonomous vehicles 202 are capable to connect to the network 208, the mission engine 230 may communicate with this autonomous vehicle(s) 202 via the network 208. In another example, assuming one or more of the autonomous vehicles 202 comprises one or more wired and/or wireless interconnection interfaces, for example, Radio Frequency (RF), Universal Serial Bus (USB), serial channel and/or the like, the mission engine 230 may communicate with this autonomous vehicle(s) 202 via the interconnection(s) available to the autonomous vehicle(s) 202. For example, the mission management system 200 may include an I/O interface comprising one or more interconnection interfaces, for example, USB, which may be connected to the USB port of one or more of the autonomous vehicle(s) 202 and used by the mission engine 230 to communicate with the connected autonomous vehicle(s) 202.

In another exemplary deployment, one or more of the autonomous vehicles 202 may connect to one or more I/O and/or network interfaces of one or more of the network resources 214 connected to the network 208, for example, a vehicle control system adapted to control the operation of one or more of the autonomous vehicles 202, a vehicle maintenance system configured to control and/or log maintenance of one or more of the autonomous vehicles 202 and/or the like. In such case, the mission engine 230 may communicate with the communicate network resource(s) 214 which may relay the communication to the autonomous vehicles 202 and vice versa.

For brevity the process 100 is described for receiving a single inspection request to inspect a single asset 204 in response. This however, should not be construed as limiting since the same process 100 may be expanded to receive a plurality of inspection requests to inspect a plurality of assets 204.

As shown at 102, the process 100 starts with the mission engine 230 receiving a request to inspection one or more of the assets 204.

The inspection request may be received from a local user 212 directly interacting with the mission management system 200, from a remote user 212 using a respective client device 210 and/or from an automated system which may request the inspection report in order to identify the state, condition and/or activity relating to the inspected asset 204 and optionally initiate one or more actions accordingly.

For example, the inspection request may be issued by the user 212 for a certain agricultural area asset 204, for example, a crop field in order to determine one or more states and/or conditions relating to the crop field, for example, a growth state and/or condition of the crop planted in the crop field, existence of one or more pests and/or herbs and/or the like. In another example, the inspection request may be issued by a certain automated system configured to monitor an operational state and/or condition of a certain infrastructure asset 204, for example, a train railway in order to identify, for example, a wearing condition of the railway, gaps, potential missing and/or damaged tracks and/or the like. In another example, the inspection request may be received from a certain automated system configured to monitor an operational state and/or condition of a certain structure asset 204, for example, an oil rig located in sea to identify, for example, an integrity state of the rig's support structure, sea life activity in proximity to the oils rig and/or the like. In another example, the inspection request may be received for inspecting a certain geographical area asset 204, for example, a grazing land in which a cattle herd is grazing in order to identify and/or track, for example, number, location and/or distribution of items of the herd in the grazing land.

The mission engine 230 may provide and/or control one or more User Interface (UIs), for example, a GUI to enable the user 210 to interact with the mission engine 230, for example, issue the request for the inspection report. In case the user 212 is a local user directly interacting with mission engine 230 via the user interface of the mission management system 200, the mission engine 230 may control the GUI displayed to the user via the user interface, for example, the screen to present information to the user 212 and may receive input from the user 212 via an input user interface, for example, a keyboard, a pointing device, a touch screen and/or the like. In another example, in case the user 212 is remote and uses one or more of the client devices 2120 to communicate and interact with the mission engine 230, the mission engine 230 may operate and present the GUI via one or more browsing applications, for example, a web browser, a local application, a local agent and/or the like executed by the client device 210 which render data received from the mission engine 230.

The mission engine 230 may further provide one or more Application Programming Interfaces (API) to enable one or more systems, applications, services and/or platforms to communicate and interact with the mission engine 230. The API may therefore include provisions, for example, functions, system calls, hooking provisions and/or the like for data exchange, for example, input, output, control, status and/or the like. Using the API, one or more automated systems may issue the inspection request.

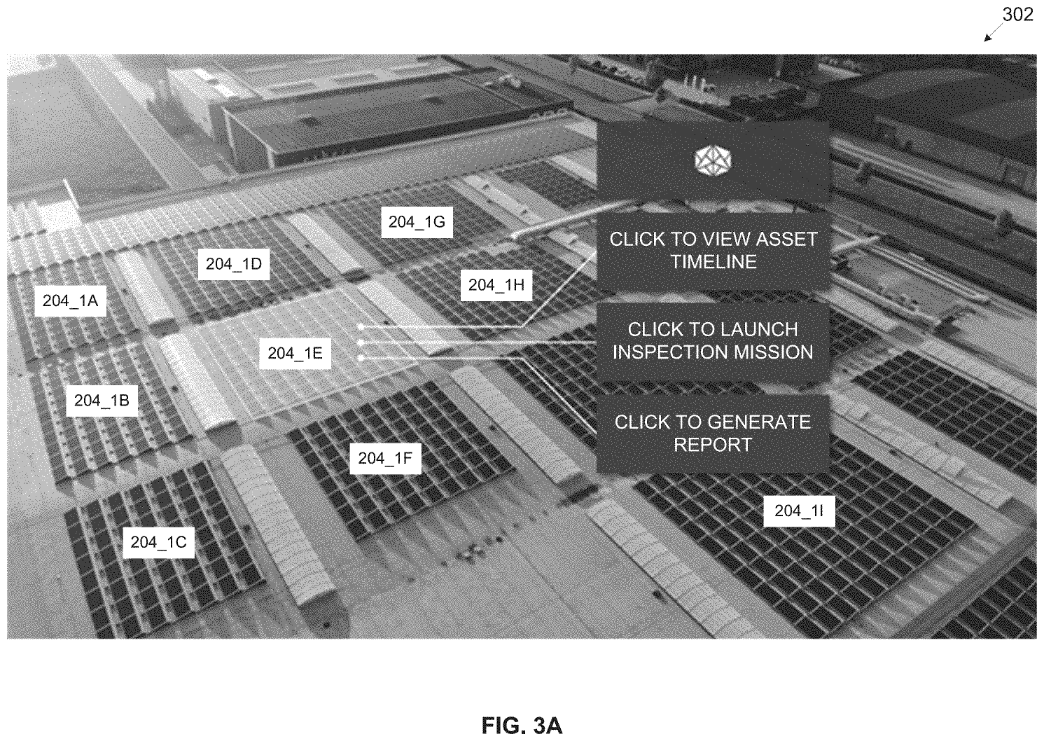

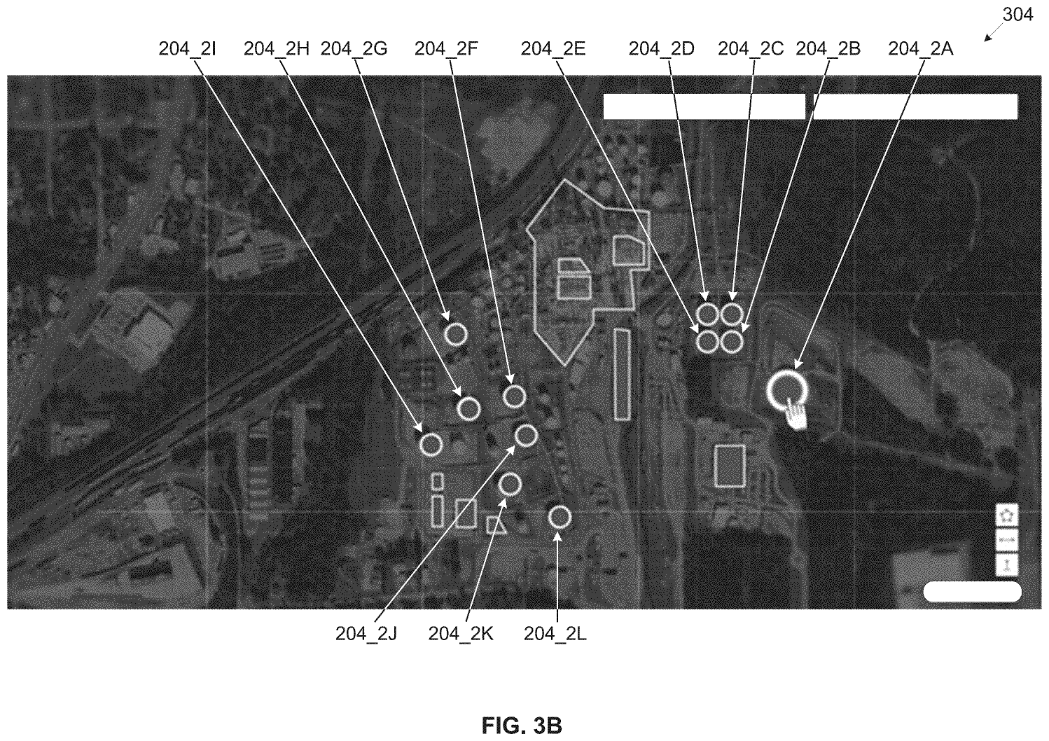

Reference is now made to FIG. 3A and FIG. 3B, which are screen captures of exemplary Graphic User Interfaces (GUI) used by users to issue requests for inspecting one or more assets, according to some embodiments of the present invention.

A screen capture 302 of an exemplary first GUI may be controlled by a mission engine such as the mission engine 230 to interact with the user 212 for receiving an inspection request to inspect a first asset 204, for example, a solar farm based energy harvesting site. Moreover, the solar farm based energy harvesting site asset 204 may be split to a plurality of smaller assets 204 each corresponding to a respective one of a plurality of solar panel field sections of the solar farm, for example, solar panel field sections 204_1A, 204_1B, 204_1C, 204_1D, 204_1E, 204_1F, 204_1G, 204_1H and 204_1I. The first GUI may present one or more of the plurality of solar panel field sections 204_1 to enable the user 212 to select one or more of the solar panel field sections 204_1 and interact with the mission engine 230 to request inspection of the selected solar panel field sections 204_1. The inspection request may be directed to identify, for example, a leakage in the solar panel pipes, a damaged solar panel and/or part thereof and/or the like in the selected solar panel field section(s) 204_1.

A screen capture 304 of an exemplary second GUI may be controlled by the mission engine 230 to interact with the user 212 for receiving a request to inspect a second asset 204, for example, a storage site containing a plurality of storage silos 204_2A, 204_2B, 204_2C, 204_2D, 204_2E, 204_2F, 204_2G, 204_2H, 204_2I, 204_2J, 204_2K and 204_2L. The second GUI may present one or more of the plurality of silos 204_2 to enable the user 212 to select one or more of the silos 204 2 and interact with the mission engine 230 to request the inspection report for the selected silos 204_2. The inspection request may be directed to identify, for example, a corrosion state the selected silo's construction, a solidity of the selected silo's structure, crack marks and/or the like.

As shown at 104, the mission engine 230 may determine what inspection data is required to accomplish an effective, reliable and/or useful inspection of the inspected asset 204.

The required inspection data may depend and/or be derived from one or more characteristics of the inspected asset 204, for example, a type of the inspected asset 204, a use of the inspected asset 204 and/or the like. The mission engine 230 may further determine what inspection data is required based on one or more inspection attributes which may be defined by the inspection request, for example, the type and/or objective of the requested inspection. For example, assuming the inspection request indicates a certain asset 204 to be inspected, for example, a solar panel and the request is directed to identify an energy conversion efficiency across the solar panel. In such case, thermal mapping data of the solar panel's top surface may be required to identify a heat distribution across the solar panel's top surface which may be indicative of the energy conversion efficiency. In another example, assuming the asset 204 requested to be inspected is a storage silo containing a liquid substance and the request is directed to identify a solidity of the silo's structure, i.e. crack signs, wearing signs and/or the like. In such case, visible light inspection data of the silos exterior structure, foundations and/or the like may be required to identify such crack and/or wear signs. However, in case the request is directed to identify potential leakage points in the silo's structure, the mission engine may determine that the required inspection data should include thermal mapping data of the silo's exterior surfaces to efficiently identify one or more flows of the liquid substance leaking from the inspected silo. In another example, assuming the asset 204 requested to be inspected is a grazing land geographical area asset 204 and the request is directed to track cattle items in the grazing land. In such case, ranging inspection data of the grazing land may be required to identify the cattle in and track its movement.

To determine the required inspection data, the mission engine 230 may analyze one or more structural models representing the inspected asset 204 in 3D space. The structural model(s) may define (express, demonstrate, depict) one or more of a plurality of asset attributes of the inspected asset 204, for example, a location, a structure, a perimeter, a dimension, a shape, an exterior surface, a surface texture and/or the like. As such the structural model(s) representing the inspected asset 204 in 3D space may define at least a location of the inspected asset 204 and/or part thereof. The structural model(s) may also define the construction of the inspected asset 204 and/or part thereof which may express a visual look of the inspected asset 204.

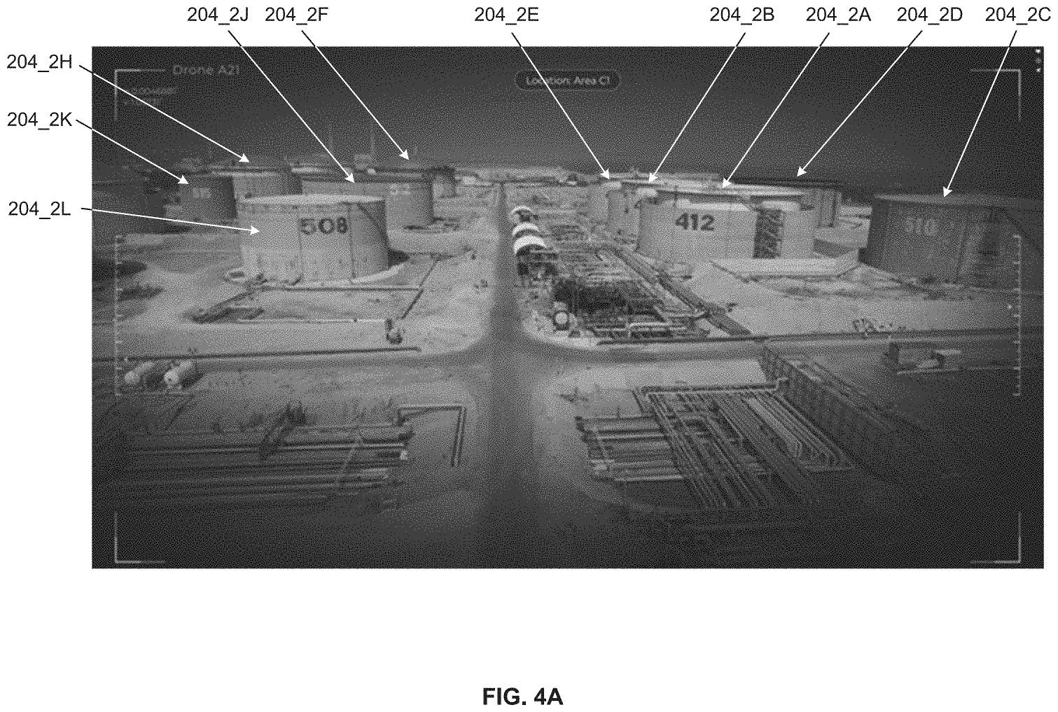

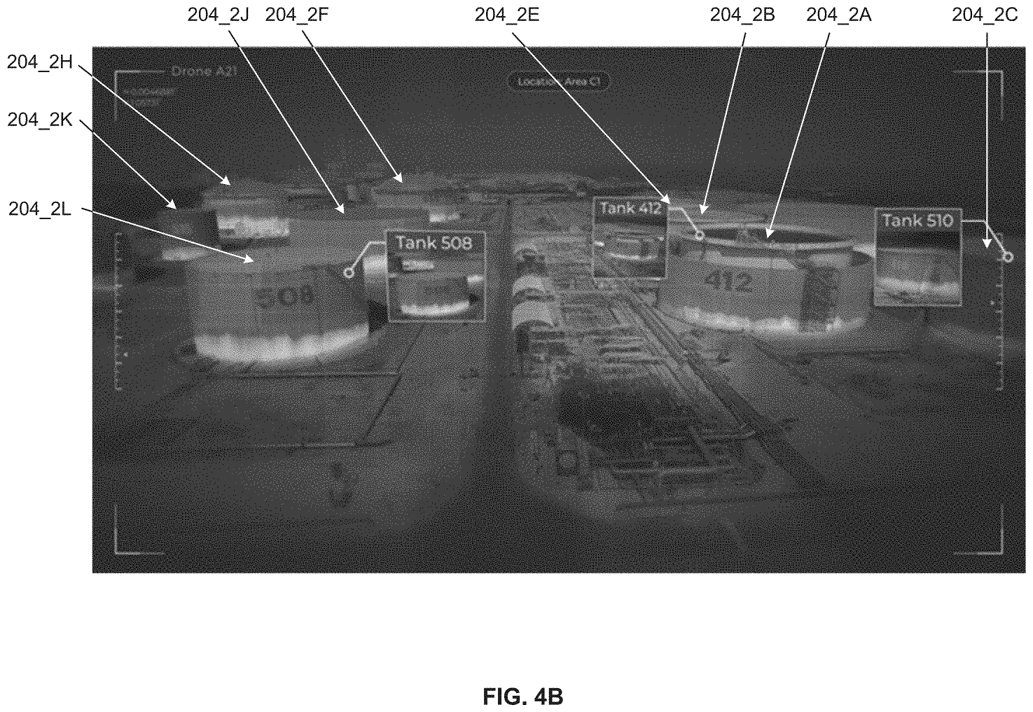

Reference is now made to FIG. 4A and FIG. 4B, which are schematic illustrations of a structural model representing an exemplary silo site comprising a plurality of silo assets in 3D space used for acquiring inspection data relating to the silo site, according to some embodiments of the present invention.

FIG. 4A depicts an exemplary silo site comprising a plurality of silos such as the silos 204_2, for example, silos 204_2A, 204_2B, 204_2C, 204_2D, 204_2E, 204_2F, 204_2G, 204_2H, 204_2I, 204_2J, 204_2K and 204_2L. FIG. 4B depicts a structural model of at least some of the silos 204_2, for example, the silo 204_2A, 204_2B, 204_2C, 204_2E, 204_2F, 204_2H, 204_2J, 204_2K and 204_2L. As seen the structural model of the silos 204_2 is derived from the actual silos 204_2 and defines a plurality of asset attributes of at least some of the silos 204_2, for example, an absolute location, a relational location of one or more of the silos 204_2 with respect to one or more other silos 204_2, perimeter of one or more of the silos 204_2, dimensions of one or more of the silos 204_2, shape of one or more of the silos 204_2, the exterior surfaces of one or more of the silos 204_2.

The structural model may be implemented and/or utilized using one or more methods, techniques and/or algorithms as known in the art, for example, 3D point array, polyhedron and/or the like. An exemplary polyhendra model of a silo such as the silo 412_2, for example, the silo 204_2A (number 412) is shown in object 1 below:

```
Object 1:
{
  “name”:“Silo E412”,
  “Type”: “Silo”,
  “Vertex”: [[0,0,1.224745], [1.154701,0,0.4082483], [−0.5773503,1,
0.4082483], [−0.5773503,−1,0.4082483], [0.5773503,1,−0.4082483],
[0.5773503,−1,−0.4082483], [−1.154701,0,−0.4082483], [0,0,
−1.224745]],
  “Edge”:[[0,1], [0,2],[0,3],[1,4], [1,5], [2,4], [2,6], [3,5], [3,6], [4,7],
  [5,7], [6,7]],
  “Face”:[[0,1,4,2], [0,2,6,3], [0,3,5,1], [1,5,7,4], [2,4,7,6], [3,6,7,5]]}
}
```

Based on analysis of the structural model(s), the mission engine 230 may analyze one or more of the asset attributes of the inspected asset 204 and may determine the required inspection data.

The mission engine 230 may further access one or more data records, for example, a file, a database and/or the like which may define the inspection data that is required for one or more of the inspections reports. One or more of the data record(s) may be created by expert users according to domain knowledge relating to the inspected assets 204. Moreover, one or more of the data record(s) may be created based on analysis of inspection data acquired for one or more previously generated inspection reports.

Optionally, one or more of the data records may be created based on training and learning of one or more ML models, for example, a neural network, an SVM and/or the like trained with one or more training datasets comprising a plurality of training data items descriptive of the inspected asset 204, for example, visual images of the asset 204, thermal and/or Infrared mapping of the asset 204, range mapping (range maps) of the asset 204 and/or the like. Each of the training data items may be labeled with a respective score indicating the contribution of the respective training data item to the effectiveness, reliability and/or usefulness of the inspection of the inspected asset 204. For example, assuming the inspection request is directed to inspect a certain infrastructure asset 204, for example, an oil pipeline to identify leakage points. The ML model(s) which may be trained and learned with inspection data acquired in a plurality of previous inspection mission of pipelines, for example, thermal maps mapping leakage points in the pipelines may indicate that leakage points are typically found in bottom sections of the pipe. Based on the indication from the ML model(s), the mission engine 230 may determine that the required inspection data may be derived from sensory data depicting the bottom sections of the pipeline, for example, thermal mapping sensory data.

Moreover, the mission engine 230 may determine that at least some of the required inspection data is already available from one or more previous inspection missions. In such case the mission engine 230 may adjust the requirements for the required inspection data to exclude the already available inspection data. For example, assuming the inspected asset 204, for example, a certain storage silo, a certain pipeline, a certain solar panel and/or the like is periodically inspected and the acquired inspection data is maintained (e.g. stored, recorded), the mission engine 230 may exclude from the required inspection data at least some of the inspection data which is already available for the inspected asset 204 from the previous periodic inspection.

As shown at 106, the mission engine 230 may compute a plurality of mission parameters of an inspection mission for acquiring the required inspection data based on analysis of one or more of the structural models representing the inspected asset 204 in 3D space.

In particular, the mission engine 230 may analyze the asset attributes defined by the structural model(s) which in addition to the asset attributes described herein before may further include one or more inspection constraints, accessibility to the inspected asset 204 and/or the like. For example, a certain inspection constraint defined by the structural model(s) of a certain inspected asset 204, for example, a solar panel may define that the solar panel must be inspected during daytime while the solar panel top surface is exposed to direct sun light. In another example, a certain inspection constraint defined by the structural model(s) of a certain inspected asset 204, for example, a storage silo containing liquid substance may not be effectively inspected for leakage during precipitation conditions, for example, rain, snow, hail and/or the like. In another example, a certain accessibility asset attribute defined by the structural model(s) of a certain inspected asset 204, for example, a factory structure may define that visibility of one or more exterior walls and/or roofs tops of the factory structure may be at least partially blocked from one or more viewpoints by one or more adjacent structures. In another example, a certain accessibility asset attribute defined by the structural model(s) of a certain inspected asset 204, for example, a storage silo may define that accessibility to close proximity of the silo may be limited due to a perimeter fence surrounding the silo.

Based on analysis of the structural model(s) of the inspected asset 204 and its asset attribute(s), the mission engine 230 may compute one or more of the mission parameters for the inspection mission in order to successfully, effectively, accurately and/or reliably acquire the required inspection data. In particular, the mission engine 230 may compute the mission parameters for acquiring (capturing) sensory data depicting the inspected asset 204 and/or part thereof which may be used as the required inspections data and/or used to generate the required inspections data.

The computed mission parameters may therefore include, for example, one or more viewpoints for capturing sensory data depicting the inspected asset 204 and/or part thereof, one or more capture angles for capturing sensory data depicting the inspected asset 204 and/or part thereof, one or more resolutions for capturing sensory data depicting the inspected asset 204 and/or part thereof, one or more access paths to the inspected asset 204 and/or the like. For example, assuming the inspected asset 204 is a structure asset 204, for example, a storage silo such as the storage silo 204_2A. In such case the mission parameters computed by the mission engine 230 for the inspection mission may include, for example, one or more view points from which the exterior of each of the faces of the silo 204_2A may be visible for inspection. In another example, assuming the inspected asset 204 is an infrastructure asset 204, for example, an oil pipeline. In such case the mission parameters computed by the mission engine 230 for the inspection mission may define, for example, a minimal resolution of the sensory data depicting the pipeline which is sufficient to visually identify potential damage in the pipeline structure.

The mission parameters may further define one or more environmental parameters for the inspection mission, for example, illumination level, maximal temperature, minimal temperature, absent of precipitation (e.g., rain, snow, hail, etc.) and/or the like. For example, assuming the required inspection data determined for a first inspection mission may be more effectively acquired during day time while light (illumination) level is high, the mission engine 230 may compute the mission parameters accordingly to define that the first inspection mission should be conducted during high illumination time. On the other hand, in case the required inspection data determined for a second inspection mission may be more effectively acquired during night time while illumination level is significantly low, and the mission parameters may be computed accordingly to define that the second inspection mission should be conducted during low illumination time. In another example, assuming the required inspection data determined for a third inspection mission may be more effectively acquired while ambient temperature is high, the mission engine 230 may compute the mission parameters accordingly to define that the third inspection should be conducted during high temperature conditions. In another example, assuming the required inspection data determined for a fourth inspection mission may not be effectively acquired during rain, the mission engine 230 may compute the mission parameters accordingly to define that the fourth inspection should not be conducted while it is raining at the area of the inspected asset 204.

The mission parameters computed by the mission engine 230 may further include and/or define one or more mission constraints for the inspection mission, for example, a mission start time, a mission end time, a section of the inspected asset 204 that needs to be inspected and/or the like.

The mission engine 230 may determine one or more of the mission constraints based on the inspection request. For example, assuming the request defines a latest time for conducting the inspection, the mission engine 230 may determine, for example, compute a start time mission constraint, an end time mission constraint and/or a duration time mission constraint for the inspection mission such that the inspection data may be acquired before the time defined by the request. In another example, the request may define a maximum cost for the inspection mission which may be used by the mission engine 230 to define a maximum cost mission constraint.

As shown at 108, the mission engine 230 may identify one or more capable autonomous vehicles 202 of the plurality of autonomous vehicles 202 which are capable of acquiring the required data by analyzing operational parameters of the autonomous vehicles with respect to the mission parameters. In other words, the mission engine 230 may analyze the operational parameters of the autonomous vehicles 202 compared to the mission parameters computed for the inspection mission in order to identify autonomous vehicle(s) 202 which are capable of successfully conducting (carrying out) the inspection mission and successfully acquire the required inspection data.

The capability, capacity and/or effectiveness of each of the different autonomous vehicles 202 to effectively carry out the inspection mission and acquire the required inspection data are naturally derived and depended on the operational parameters of the respective autonomous vehicle 202 and/or of their sensors 206. This means that due to their different operational parameters one or more of the autonomous vehicle 202 may be capable to more effectively and/or efficiently accomplish the inspection mission and acquire the required inspection data compared to one or more other autonomous vehicle 202.

The mission engine 230 may therefore analyze the operational parameters of the autonomous vehicles 202 and their sensors 206 with respect to the mission parameters computed for the inspection mission in order to identify which of the autonomous vehicles is capable of acquiring the required inspection data determined to be acquired during the inspection mission.

For example, assuming the inspection mission is directed to acquire inspection data relating to a large geographical area asset 204, for example, a large agricultural area such as, for example, a large crop field, in order, for example, to identify a growth state of the crop, a pest condition and/or the like. The mission parameters computed for the inspection mission may define, for example, (1) the required inspection data is based on visual sensory data, (2) one or more aerial viewpoints from which the crop field is visible and the visual sensory data may be acquired, (3) a minimal resolution of the visual sensory data which is sufficient for detecting pest in the crop and/or blossom of the crop and/or the like. In such case, based on analysis of the operational parameters of the autonomous vehicles 202 and their sensors 260 with respect to the mission parameters, the mission engine 230 may identify one or more UAVs 202A1 equipped with one or more high resolution and wide FOV imaging sensors 206 which may be capable to effectively acquire the required inspection data, i.e., the visual sensory data depicting the large crop field. However, the crop field may include one or more obscure areas due to, for example, a terrain depression, a prominent terrain feature (e.g., bolder, hill, tree, structure, etc.) and/or the like. In such case the mission parameters computed for the inspection mission may define additional viewpoints from which the obscure area(s) may be visible. Such viewpoints may typically be at lower altitude and possibly in proximity to the ground and/or to one or more obstacles. In this scenario, based on analysis of the operational parameters of the autonomous vehicles 202 and their sensors 260 with respect to the mission parameters, the mission engine 230 may determine that the UAV(s) 202A1 may be incapable of acquiring the required visual sensory data, at least for the obscure area(s). The mission engine 230 may further identify one or more high maneuverability and/or low altitude drones 202A2 which may be capable to successfully and effectively acquire the required visual sensory data relating to the large crop field or at least the visual sensory data relating to the obscure area(s).

In another example, assuming the inspection mission is directed to acquire inspection data relating to a certain infrastructure asset 204, for example, a pipeline in order to identify, for example, leaks in the pipe. Leaks may typically occur in bottom sections of the pipeline which may be deployed such that the bottom sections are visible only from ground level. The mission parameters computed for the inspection mission may define, for example, that the required inspection data is based on thermal mapping sensory data, one or more ground level viewpoints from which the bottom sections of the pipe are visible and the thermal mapping sensory data may be acquired and/or the like. In such case, based on analysis of the operational parameters of the autonomous vehicles 202 and their sensors 260 with respect to the mission parameters, the mission engine 230 may identify one or more ground autonomous vehicles 202B which may effectively acquire the required inspection data, specifically the thermal mapping sensory data of the bottom sections of the pipeline.

Based on their operational parameters, the mission engine 230 may further identify one or more of the autonomous vehicles 202 which are capable of acquiring the required data while one or more environmental conditions are identified at the location of the inspected asset 204, for example, temperature (level), humidity (level), illumination (high, low), rain, snow, haze, fog, smog and/or the like. For example, assuming it is estimated that high temperatures will apply at the location of the inspected asset 204, the mission engine 230 may identify one or more of the autonomous vehicles 202 which are capable to operate and successfully acquire the required inspection data, specifically the sensory data during high temperature conditions. In another example, assuming it is estimated that rain conditions will apply at the location of the inspected asset 204, the mission engine 230 may identify one or more of the autonomous vehicles 202 which are capable to operate and successfully acquire the required inspection data, specifically the sensory data during rainy conditions.

The mission engine 230 may obtain, for example, receive, retrieve, fetch and/or the like the operational parameters of one or more of the autonomous vehicles 202 from one or more data records, a file, a list, a database and/or the like which may define the inspection data that is required for one or more of the inspections. The data record(s) may be stored locally by the mission management system 200, for example, the storage 224 and/or stored remotely by one or more of the network resources 214 accessible to the mission management system 200 via the network 208. The mission engine 230 may further communicate with one or more of the network resources 214 to obtain one or more of the operational parameters of one or more of the autonomous vehicles 202. For example, the mission engine 230 may obtain some operational parameters of one or more of the autonomous vehicles 202, for example, availability, operational cost and/or the like by communicating, via the network 208, with a vehicle control system configured to track an operational status of one or more of the autonomous vehicles 202.

As shown at 110, the mission engine 230 may select one or more of the capable autonomous vehicle(s) 202 to carry out the inspection mission and acquire the inspection data, specifically capture required sensory data which may be used as the inspection data and/or used to generate the inspection data. In particular, the mission engine 230 may select for the inspection mission the capable autonomous vehicle(s) 202 which are estimated to most effectively and accurately acquire the required inspection data.

The mission engine 230 may therefore apply one or more optimization functions for selecting one or more of the capable autonomous vehicles 202 to carry out the inspection mission and acquire the required inspection data. The optimization function(s) may be directed to minimize one or more operational objectives of the inspection mission, for example, a shortest route of the selected capable autonomous vehicle(s) 202, a lowest operational cost of the selected capable autonomous vehicle(s) 202, a minimal number of autonomous vehicle(s) 202, a shortest mission time of the inspection mission, an earliest completion time of the inspection mission, a maximal utilization of the plurality of autonomous vehicles 202 and/or the like.

For example, assuming the inspected asset 204 is a structure asset 204, for example, the silo 204_2A and one of the capable autonomous vehicles 202 identified as capable for carrying out the inspection mission is the drone 202A2. Further assuming a first optimization function defines using a minimal total number of the capable autonomous vehicles 202 for acquiring the required inspection data relating to the inspected asset 204 while a second optimization function defines a shortest mission time. In such case, when selecting capable autonomous vehicle(s) 202 according to the first optimization function, the mission engine 230 may select a single drone 202A2 for the inspection mission to acquire the required inspection data of the silo 204_2A thus reducing the number of autonomous vehicles 202 used for the inspection mission. However, when selecting capable autonomous vehicle(s) 202 according to the second optimization function, the mission engine 230 may select a plurality of drones 202A2 for the inspection mission to simultaneously acquire the required inspection data of the silo 204_2A thus significantly reducing the mission time. Moreover, in case the selection is done according to the second optimization function, the mission engine 230 may select multiple UAVs 202A1 for conducting the inspection mission thus further reducing the mission time.

In another example, the mission engine 230 may select the capable autonomous vehicle(s) 202 according to the third optimization function defining a lowest operational cost of the autonomous vehicle(s) selected to acquire the inspection data. For example, assuming the inspected asset 204 is an agricultural area, for example, a crop field and the capable autonomous vehicles 202 identified as capable for carrying out the inspection mission include the UAV 202A1 and the drone 202A2. However, while both the UAV 202A1 and the drone 202A are capable of carrying out the inspection mission, the operational cost of the inspection mission may be different when using the UAV 202A1 or the drone 202A. For example, the operational cost of the drone 202A1 may be significantly low per hour but it may take the drone 202A2 longer to complete the inspection mission compared to the UAV 202A1 which may entail higher operational cost per hour but may complete the inspection mission in shorter time than the drone 202A2. The mission engine 230 may therefore apply the third optimization function to select the UAV 202A1 or the drone 202A2 to conduct the inspection mission and acquire the required inspection data.

In another example, the mission engine 230 may select the capable autonomous vehicle(s) 202 according to a fourth optimization function defining an earliest completion time of the inspection mission. For example, assuming the mission engine 230 identifies two capable autonomous vehicles 202 for carrying out the inspection mission, for example, the UAV 202A1 and a certain ground autonomous vehicle 202B. While the UAV 202A1 may complete the inspection in shorter time (duration) compared to the ground autonomous vehicle 202B, due to limited availability of the UAV 202A1 the inspection mission may be completed sooner when using the ground autonomous vehicle 202B. The mission engine 230 may therefore select the ground autonomous vehicle 202B to conduct the inspection mission.

As shown at 112, the mission engine 230 may compute operation instructions for operating the selected capable autonomous vehicle(s) 202 selected to carry out the inspection mission and acquire the inspection data, specifically capture the required sensory data.

The instructions computed by the mission engine 230 for the selected capable autonomous vehicle(s) 202 may include, for example, navigational instructions directing the selected capable autonomous vehicle(s) 202 to the inspected asset 204. In another example, the instructions computed by the mission engine 230 for the selected capable autonomous vehicle(s) 202 may include navigational instructions for a path along the viewpoint(s) defined by the mission parameters for acquiring the required sensory data (inspection data) and/or part thereof. In another example, the instructions computed by the mission engine 230 for the selected capable autonomous vehicle(s) 202 may include capturing instructions for the sensor(s) 206 used by the selected capable autonomous vehicle(s) 202 to acquire the required sensory data and/or part thereof, for example, a capture mode (e.g. visual data, thermal data, ranging data, etc.), resolution, FOV and/or the like.

Optionally, the instructions computed by the mission engine 230 for the selected capable autonomous vehicle(s) 202 may define one or more timing and/or scheduling instructions. For example, assuming a certain mission is directed to acquire inspection data relating to a certain inspected asset 204, for example, a solar panel which is defined to be inspected during daytime. In such case, the mission engine 230 may schedule the inspection mission for acquiring the required inspection data to be launched during daytime preferably during noon time while solar radiation is highest. In another example, assuming a certain mission is directed to acquire inspection data relating to a certain inspected asset 204, for example, the storage silo 204_2A containing liquid substance which may not be effectively inspected for leakage during precipitation conditions. In such case, the mission engine 230 may schedule the inspection mission for acquiring the required inspection data to be launched at a time during which the environmental conditions at the location of the silo 204_2A is estimated to be dry, i.e., no rain, no snow, no hail, low humidity and/or the like.

Optionally, the operation instructions computed by the mission engine 230 for the selected capable autonomous vehicle(s) 202 may further include one or more reference elements which may be used by one or more of the selected capable autonomous vehicle(s) 202 to reliably and/or accurately identify one or more asset features of the inspected asset 204. The reference elements may relate to one or more features of the inspected asset 204 which may be expressed in one or more representations, for example, visual, audible, transmission, emission and/or the like and may be therefore intercepted, recognized and/or otherwise identified by one or more of the selected capable autonomous vehicle(s) 202 using one or more respective sensors, receives and /or the like, for example, an imaging sensor, an RF receiver and/or the like.

The reference elements may include, for example, one or more images of the inspected asset 204 which may be used by one or more of the selected capable autonomous vehicle(s) 202 to identify the inspected asset 204 and/or part thereof. For example, assuming the inspected asset 204 is a geographical area, for example, a crop field, the operation instructions may include one or more images of one or more features present in the crop field and/or in its close vicinity, for example, a structure, a road, a path, a bolder, a river and/or the like to enable one or more of the selected capable autonomous vehicle(s) 202 to identify the crop field.

In another example, the reference elements may include one or more feature vectors and/or simulations corresponding to one or more features of the inspected asset. For example, assuming the inspected asset 204 is an oil rig, the operation instructions may include one or more feature vectors and/or simulations corresponding to one or more features of the oil rig, for example, a drilling tower, a helicopter landing pad, a support pole and/or the like which may be used by one or more of the selected capable autonomous vehicle(s) 202 to deterministically identify the silo 204_2A among the other silos 204_2.

In another example, the reference elements may include one or more visual identification code attached to the inspected asset 204 to enable one or more of the selected capable autonomous vehicle(s) 202 to identify the inspected asset 204. For example, assuming the inspected asset 204 is the silo 204_2A, the operation instructions may include the number “412” printed on the silo 204_2A which may be used by one or more of the selected capable autonomous vehicle(s) 202 to deterministically identify the silo 204_2A among the other silos 204_2.

In another example, the reference elements may include one or more transmitted identification codes transmitted in proximity to one or more features of the inspected asset 204 via one or more short range wireless transmission channels to enable one or more of the selected capable autonomous vehicle(s) 202 to identify the inspected asset 204. For example, assuming the inspected asset 204 is the silo 204_2A, the operation instructions may include a code “412” which is transmitted continuously, periodically and/or on demand be a short range transmitter deployed in, on and/or around the silo 204_2A and may be intercepted by one or more of the selected capable autonomous vehicle(s) 202 to deterministically identify the silo 204_2A among the other silos 204_2.

As shown at 114, the mission engine may transmit the operation instructions to the selected capable autonomous vehicle(s) 202.

The mission engine 230 may transmit the operation instructions using the connectivity capabilities available to the selected capable autonomous vehicle(s) 202 as described herein before, for example, via the network 208, via local wired and/or wireless interconnection interfaces (e.g., USB, RF, etc.), via one or more of the network resources 214 (e.g. the vehicle control system, the vehicle maintenance system, etc.) and/or the like.

Optionally, the mission engine 230 computes a plurality of instruction sets each for a respective one of a plurality of operations plans. Each operation plan is created for one or more of the autonomous vehicles 202 identified to be capable of carrying out the inspection mission to acquire the required inspection data. The mission engine 230 may further select an optimal operation plan from the plurality of according to one or more of the optimization functions.

For example, assuming the inspected asset 204 is the silo 204_2A, the mission engine 230 may compute several instruction sets, for example, two for a two operations plans of a single selected capable autonomous vehicle 202, for example, the drone 202A2. A first operation plan may be applied for operating the drone 202A2 in a vertical movement pattern from bottom to top of the silo 204_2A while gradually circling the silo 204_2A and the mission engine may compute a first set of operation instructions accordingly. A second operation plan may be applied for operating the drone 202A2 in a horizontal movement pattern around the silo 204_2A which gradually ascends from bottom to top of the silo 204_2A and the mission engine may compute a second set of operation instructions accordingly. The mission engine 230 may then apply one or more of the optimization functions to select one of the two operation plans, for example, a shortest time optimization, a minimal cost optimization and/or the like.

In another example, assuming the inspected asset 204 is the solar panel field silo 204_1E, the mission engine 230 may compute several instruction sets, for example, two for a two operation plans, a first operation plan for one or more UAVs such as the UAV 202A1 and a second operation plan for one or more drones such as the drone 202A2. The mission engine 230 may then apply one or more of the optimization functions to select one of the two operation plans, for example, a shortest duration optimization, a minimal cost optimization and/or the like.

Optionally, the mission engine 230 splits the inspection mission to a plurality of sub-missions where each of the sub-missions is directed to acquire a respective one of a plurality of portions of the required inspection data. The mission engine 230 may compute mission parameters for each of the sub-missions and may further select a plurality of capable autonomous vehicles 202 which are each identified, based on analysis of their operational parameters with respect to the mission parameters, as capable to carry out a respective one of the plurality of sub-missions and acquire the respective portion of the required inspection data defined for acquiring during the respective sub-mission. The mission engine 230 may compute operation instructions accordingly for each of the plurality of selected capable autonomous vehicles 202 to operate the respective selected capable autonomous vehicle 202 to carry out its respective inspection mission and acquire its respective portion of the required inspection data.

For example, assuming the inspection mission is directed to acquire inspection data relating to a large geographical area asset 204, for example, a large agricultural area such as, for example, a large crop field, in order, for example, to identify a growth state of the crop, a pest condition and/or the like. Further assuming that the crop field may include one or more obscure areas due to, for example, a terrain depression, a prominent terrain feature (e.g., bolder, hill, tree, structure, etc.) and/or the like. In such case, the mission engine 230 may split the inspection mission to a plurality of sub-missions, for example, three sub-missions, a first sub-mission for acquiring required inspection (sensory) data relating to non-obscure areas of the crop field, a second sub-mission directed to acquire required sensory data relating to areas obscured by one or more prominent features present in the crop field and a third sub-mission directed to acquire required sensory data relating to ground depressions present in the crop field.

Optionally, the inspection request relates to multiple assets 204 rather than just a single asset 204. In such case, the mission engine 230 may compute the mission parameters for an inspection mission directed to acquire inspection data of the multitude of assets 204 and may analyze the operational parameters of the autonomous vehicles 202 with respect to the mission parameters as described herein before to identify one or more of the autonomous vehicle 202 which are capable of carrying out the inspection mission and acquire inspection data, specifically sensory data depicting the multitude of inspected assets 204. After selecting one or more of the capable autonomous vehicles 202, the mission engine 230 may compute operation instructions for the selected capable autonomous vehicle(s) 202 for acquiring the inspection data relating to the multitude of assets 204. The computed operation instructions may further define a route between at least some of the multitude of inspected assets 204. Moreover, the mission engine 230 may select an optimal route between the multitude of inspected assets 204 according to one or more of the optimization functions, for example, shortest route, lowest cost route and/or the like which may define an optimal route between the multitude of inspected assets 204 and/or an optimal order of inspection of the multitude of inspected assets 204.

Optionally, the mission engine 230 receives a plurality of inspection requests relating to a plurality of assets 204. In such case, the mission engine 230 may first determine the inspection data required for each of a plurality of inspection mission and may compute mission parameters accordingly for each of the inspection missions. The mission engine 230 may then analyze the operational parameters of the autonomous vehicles 202 with respect to the mission parameters of the plurality of inspection missions and may select for each inspection mission one or more capable autonomous vehicles 202 which are capable of acquiring the required inspection data defined for the respective inspection mission. The mission engine 230 may compute operation instructions for each of the plurality of inspection missions for each of the selected capable autonomous vehicle(s) 202 to acquire the respective required inspection data. The mission engine 230 may further schedule the plurality of inspection missions according to availability of the selected capable autonomous vehicle(s) 202.

For example, assuming the plurality of inspection requests relate to a plurality of inspected assets 204 which are significantly distant from each other and may not be inspected in a single inspection mission. The mission engine 230 may therefore define a plurality of inspection missions each directed to acquire respective inspection data relating to only a subset of one or more of the plurality of inspected assets 204. Further assuming that the mission engine 230 identifies and selects for the plurality of inspection missions the same one or more autonomous vehicle(s) 202 which are identified as capable to carry out the inspection missions and acquire the required inspection data. The mission engine 230 may thus schedule the plurality of inspection missions according to availability of the selected capable autonomous vehicle(s) 202. For example, the mission engine 230 may prioritize the inspection missions and may schedule initiation of the inspection missions according to their priority such that after one inspection mission is complete and the selected capable autonomous vehicle(s) 202 become available again, the next highest priority inspection mission may be launched.

As shown at 116, which is an optional step, the mission engine 230 may initiate one or more additional inspection missions to acquire additional inspection data in case the acquired inspection data is incompliant, for example, partial, incomplete, insufficient, insufficiently accurate, under quality and/or the like. For example, the mission engine 230 may initiate the additional inspection mission(s) based on analysis of the acquired inspection data with respect to the inspection request. In particular, the analysis of the acquired inspection data may be done compared and/or with respect to the required inspection data as determined in step 104 to evaluate the compliance of the actually acquired inspection data with the computed required inspection data.

The analysis of the acquired inspection data and to evaluate compliance of the acquired inspection data may be typically done by one or more other systems, applications, services and/or the like configured to analyze inspection data. Analysis of the acquired inspection data may be done using one or more methods, techniques and/or algorithms as known in the art, for example, computer vision, image processing and/or the like to analyze the inspection data, specifically the sensory data, for example, imagery data, ranging data, thermal mapping data and/or the like acquired by the selected capable autonomous vehicle(s) 202 for the inspected asset 204 during the inspection mission.

Optionally, one or more ML models, for example, a neural network, an SVM and/or the like may be trained and learned to analyze the acquired inspection data to determine compliance, specifically, for quality, accuracy, completeness, reliability and/or the like of the acquired inspection data. Moreover, the ML model(s) may be further trained and/or learned to analyze the acquired inspection with respect to the required inspection data determined in step 104 to evaluate compliance of the acquired inspection data with the computed required inspection data. The ML model(s) may be trained using one or more training datasets comprising a plurality of training data items descriptive of the inspected asset 204, for example, visual images of the asset 204, thermal and/or Infrared mapping of the asset 204, range mapping (range maps) of the asset 204 and/or the like. Each of the training data items may be further labeled with a respective score indicating compliance of the respective training data item with a respective required inspection data item.

The trained ML model(s) may be therefore applied to the acquired inspection data to classify the compliance of each acquired inspection data item, for example, an image, a thermal image, a range map and/or the like. For example, assuming the acquired inspection data includes one or more visible light images captured to depict at least part of a certain inspected asset 204, for example, the storage silo 204_2A. The trained ML model(s) may be applied to the captured image(s) to evaluate their compliance in general and with the required inspection data in particular.

In case, based on the compliance analysis, the mission engine 230 determines that the acquired inspection data is incompliant, the process 100 may branch to step 104 to initiate an additional inspection mission to acquire additional inspection data which may overcome the deficiency in the currently available acquired inspection data.

Naturally, this feedback loop may be repeated in a plurality of iterations each to initiate an additional inspection mission until the mission engine 230 determines that the acquired inspection data is compliant and/or until one or more mission thresholds defined for the inspection mission are reached, for example, a maximum mission number, a maximum accumulated mission time, a maximum accumulated cost and/or the like.

Moreover, the mission engine 230 may further define one more mission constraints to increase the probability of acquiring compliant acquired inspection data in the additional inspection mission. Continuing the previous example, assuming the acquired inspection data of the storage silo 204_2A is incompliant since at least part of the storage silo 204_2A is not sufficiently illuminated, the mission engine 230 may define that the additional inspection mission launched to acquire inspection data relating to the storage silo 204_2A should be scheduled for a time of high illumination (light), for example, in the middle of the day, in clear weather and/or the like. Additionally and/or alternatively, the mission engine 230 may define that the additional inspection mission launched to acquire inspection data relating to the storage silo 204_2A should be conducted by one or more autonomous vehicles capable to illuminate at least part of the storage silo 204_2A and capture the required sensory data.

As stated herein before, the inspection data acquired by the selected capable autonomous vehicle(s) 202 during the inspection mission may be used for a plurality of applications, objectives and/or goals.

For example, the inspection data acquired for the inspected asset 204 may be used to create, enhance and/or update one or more of the structural models representing the asset 204 in 3D space. This may serve to maintain an updated, reliable and/or accurate representation of the asset 204 which in turn may be used, for example, to better determine the required inspection data to robustly inspect the asset 204, compute more accurate mission parameters for future inspection mission of the asset 204 which eventually may significantly improve accuracy, quality, completeness, reliability and/or the like of the inspection data relating to the asset 204.

In another example, the inspection data acquired for the inspected asset 204 may be used to generate one or more inspection reports relating to the inspected asset 204, for example, express one or more states, conditions and/or activities relating to the inspected asset 204. The analysis of the inspection data may reveal features, elements and/or items relating to the inspected asset 204 and may further express states, conditions and/or activities relating to the inspected asset 204. For example, assuming the inspection request was directed to identify structure solidity of a certain structure asset 204, for example, the storage silo 204_2B, i.e. crack signs, wearing signs and/or the like. In such case, the analysis of the inspection data acquired for the silo 204_2A, for example, visible light image(s) may include computer vision analysis of the images(s) to identify such structural damage marks. In another example, assuming the inspection request was directed to identify leakage points in the structure of the storage silo 204_2A, the analysis of the inspection data acquired for the silo 204_2A, for example, thermal mapping and/or thermal images may include image processing and/or signal processing to identify potential leakage points. In another example, assuming the inspection request was directed to track items of a cattle herd in a certain geographical area, for example, the grazing land, the analysis may include computer vision analysis to the inspection data acquired for the grazing land, for example, ranging data to identify the cattle.

Optionally, based on the analysis of the acquired inspection data, the inspection report may be generated to include one or more maintenance recommendations for the inspected asset 204. For example, assuming that the inspection mission is directed to acquire inspection data relating to the inspected asset 204, for example, the silo 204_2A. Further assuming that based on analysis of the sensory data (inspection data), for example, imagery data (images) of the inspected silo 204_2A, corrosion is identified in one or more surfaces and/or structural joints of the silo 204_2A. In such case, the inspection report may include one or more recommendations, for example, tend, repair and/or further monitor the corroded sections, stop using the silo 204_2A and/or the like.

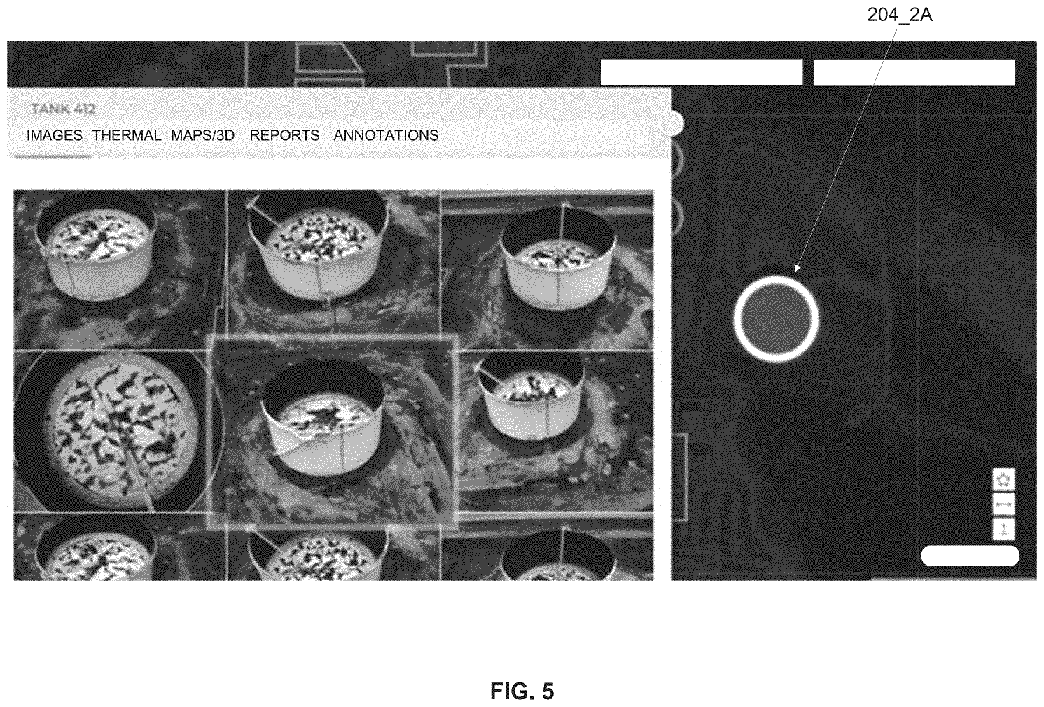

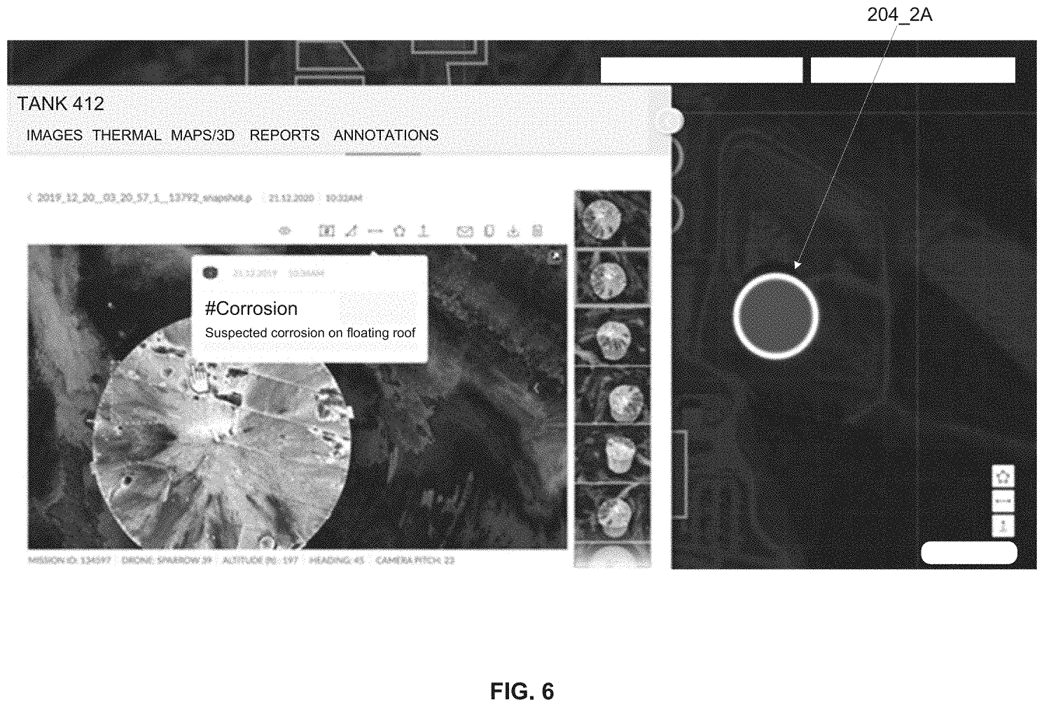

Reference is now made to FIG. 5, which is screen capture of exemplary inspection data of an exemplary silo asset acquired by autonomous vehicle(s) selected and operated automatically according to mission parameters derived from an inspection request, according to some embodiments of the present invention. Reference is also made to FIG. 6, which is an exemplary inspection report generated for an exemplary silo asset based on data acquired by autonomous vehicle(s) selected and operated automatically according to mission parameters derived from an inspection request, according to some embodiments of the present invention.

As seen in FIG. 5, inspection data collected for an exemplary asset such as the asset 204, for example, the silo 204_2A by one or more autonomous vehicles such as the autonomous vehicles 202 may include one or more images depicting the silo 204_2A captured from one or more viewpoints, one or more angles optionally in one or more resolutions.

As seen in FIG. 6, based on analysis of one or more of the images depicting the silo 204_2A, an inspection report may be generated for the silo 204_2A describing, for example, the structural state and/or maintenance conditions of the silo 204_2A, for example, presence of corrosion on a floating roof of the silo 204_2A.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the terms autonomous vehicle, sensor technologies and models in 3D space are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method of automatically selecting and operating autonomous vehicles to optimize inspection mission launched to acquire inspection data, comprising:
using at least one processor for:
receiving a request to inspect at least one of a plurality of assets;
analyzing at least one structural model representing the at least one asset to determine required inspection data and compute a plurality of mission parameters of an inspection mission for acquiring the inspection data;
analyzing a plurality of operational parameters of each of a plurality of autonomous vehicles with respect to the plurality of mission parameters to identify at least one of the plurality of autonomous vehicles which is capable of acquiring the inspection data;
computing operation instructions for at least one capable autonomous vehicle selected to acquire the inspection data; and
transmitting the operation instructions for operating the at least one selected capable autonomous vehicle to acquire the inspection data.

2. The method of claim 1, wherein the acquired inspection data is used for at least one of: generating an inspection report relating to the at least one asset and enhancing the at least one structural model representing the at least one asset.

3. The method of claim 1, further comprising initiating at least one additional inspection mission to acquire additional inspection data in case it is determined, based on analysis of the acquired inspection data, that the acquired inspection data does not to comply at least partially does with the required inspection data.

4. The method of claim 3, wherein the analysis of the acquired inspection data compared to the required inspection data is conducted by at least one Machine Learning (ML) model trained using a plurality of training inspection datasets.

5. The method of claim 1, wherein each of the plurality of autonomous vehicles is a member of a group consisting of: a ground vehicle, an aerial vehicle and a naval vehicle.

6. The method of claim 1, wherein the plurality of assets comprise at least one of: a geographical area, a structure, an infrastructure and a stockpile.

7. The method of claim 1, wherein the at least one structural model representing the at least one asset in a three dimensional (3D) space defines a plurality of asset attributes of the at least one asset, the plurality of asset attributes comprise: a location, a structure, a perimeter, a dimension, a shape, an exterior surface, an inspection constraint and an accessibility.

8. The method of claim 1, wherein the mission parameters further comprise at least one mission constraint for the inspection mission, the at least one mission constraint is a member of a group consisting of: a mission start time, a mission end time, a section of the at least one asset and a maximum mission cost.

9. The method of claim 1, wherein each of the plurality of autonomous vehicles is equipped with at least one sensor configured to capture at least data, the at least one sensor is a member of a group consisting of: a visual light camera, a video camera, a thermal camera, a night vision sensor, an infrared camera, an ultraviolet camera, a depth camera, a ranging sensor, a Laser imaging, Detection and Ranging (LiDAR) and a Radio Detection and Ranging (RADAR).

10. The method of claim 8, wherein the plurality of operational parameters include at least some members of a group consisting of: a speed, a range, an altitude, maneuverability, a power consumption, availability, an operational cost, a resolution of the at least one sensor, a Field of View (FOV) of the at least one sensor and a range of the at least one sensor.

11. The method of claim 10, wherein the operational parameters of at least one of the plurality of autonomous vehicles further include a capability of the at least one of the plurality of autonomous vehicles to acquire the inspection data under at least one environmental condition, the at least one environmental condition is a member of a group consisting of: temperature, humidity, illumination, rain, snow, haze, fog and smog.

12. The method of claim 1, wherein the at least one capable autonomous vehicle is selected according to at least one optimization function, the at least one optimization function is directed to minimize at least one operational objective of the inspection mission, the at least one operational objective is a member of a group consisting of: a shortest route, a lowest operational cost, a minimal number of autonomous vehicles, a shortest mission time and a maximal utilization of the plurality of autonomous vehicles.

13. The method of claim 12, further comprising:
computing a plurality of instruction sets each for a respective one of a plurality of operation plans for at least one autonomous vehicle identified to be capable of acquiring the inspection data, and
selecting an optimal operation plan from the plurality of operation plans according to the at least one optimization function.

14. The method of claim 1, further comprising:
splitting the inspection mission to a plurality of sub-missions,
selecting a plurality of capable autonomous vehicles each capable to accomplish a respective one of the plurality of sub-missions, and
computing operation instructions for each of the plurality of capable autonomous vehicles to carry out the respective sub-mission.

15. The method of claim 1, wherein the operation instructions further comprise at least one reference element used by the at least one selected capable autonomous vehicle to identify at least one asset feature of the at least one asset during the inspection mission, the at least one reference element is a member of a group consisting of: an image of the at least one asset feature, a feature vector representing the at least one asset feature, a simulation of the at least one asset feature, a visual identification code attached to the at least asset feature and a transmitted identification code transmitted in proximity to the at least one asset feature via at least one short range wireless transmission channel.

16. The method of claim 1, wherein the operation instructions computed for the at least one selected capable autonomous vehicle define a route between at least some of the plurality of assets in case the request relates to inspection of multiple assets of the plurality of assets.

17. The method of claim 1, further comprising scheduling the inspection mission according to at least one environmental condition during which the at least one capable autonomous vehicle is estimated to successfully accomplish the inspection mission.

18. The method of claim 1, further comprising:
receiving a plurality of requests to inspect multiple assets of the plurality of assets,
determining the inspection data required for each of the plurality of requests,
selecting at least one capable autonomous vehicle to acquire the required inspection data,
computing operation instructions for a plurality of inspection missions for the at least one selected capable autonomous vehicle to acquire the required inspection data, and
scheduling the plurality of inspection missions according to availability of the at least one selected capable autonomous vehicle.

19. A system for automatically selecting and operating autonomous vehicles to optimize inspection mission launched to acquire inspection data, comprising:
at least one processor configured to execute a code, the code comprising:
code instructions to receive a request to inspect at least one of a plurality of assets;
code instructions to analyze at least one structural model representing the at least one asset to determine required inspection data and compute a plurality of mission parameters of an inspection mission for acquiring the inspection data;
code instructions to compute a plurality of mission parameters based on the at least one asset attribute;
code instructions to analyze a plurality of operational parameters of each of a plurality of autonomous vehicles respect to the plurality of mission parameters to identify at least one of the plurality of autonomous vehicles which is capable of acquiring the inspection data;
code instructions to compute operation instructions for at least one capable autonomous vehicle selected to acquire the inspection data; and
code instructions to transmit the operation instructions for operating the at least one selected capable autonomous vehicle to acquire the inspection data.

20. A computer program product comprising program instructions executable by a computer, which, when executed by the computer, cause the computer to perform a method according to claim 1.
